(19) United States
(12) Patent Application Publication
(10) Pub. No.: US 2018/0326617 A1
(43) Pub. Date: Nov. 15, 2018

(54) DIAMOND WIRE SAW

(71) Applicant: STONE & RESOURCE INDUSTRY R&D CENTER, Hualien County (TW)

(72) Inventors: Chih-Chen KUO, Hualien County (TW); Ching-Fang CHEN, Hualien County (TW); Bo-Hong WU, Hualien County (TW); Chao-Hung LEE, Kaohsiung City (TW); Bo-Hua CHENG, Hualien County (TW)

(73) Assignee: STONE & RESOURCE INDUSTRY R&D CENTER, Hualien County (TW)

(21) Appl. No.: 15/593,544

(22) Filed: May 12, 2017

(51) Int. Cl. B28D 1/08; B23D 61/18

(52) U.S. Cl. CPC B28D 1/08; B23D 61/185

(57) ABSTRACT

A diamond wire saw includes a steel wire, a molded sleeve, and a plurality of diamond bead bearing units. The molded sleeve surrounds and is bonded to the steel wire. The diamond bead bearing units are disposed around and bonded to the molded sleeve. Each of the diamond bead bearing units includes a tubular body and a functional layer that covers the tubular body and that contains a plurality of abrasive diamond particles. The molded sleeve is made of polyether-type thermoplastic polyurethane, and has a Shore hardness of greater than or equal to 70 D.

### FIELD

The disclosure relates to a wire saw, and more particularly to a diamond wire saw for cutting stones.

### BACKGROUND

Chinese Utility Model Patent No. CN 203344192 U discloses a small-diameter diamond wire saw including a steel wire, an isolation sleeve that surrounds the steel wire, and a plurality of diamond bead bearing units that are separately disposed around and bonded to the isolation sleeve.

Each of the diamond bead bearing units has a tubular body and a functional layer. The functional layer includes an adhering layer portion adhered to the tubular body and a plurality of abrasive diamond particles dispersed on the adhering layer portion. The small-diameter diamond wire saw is made by an injection molding process including: cleaning and degreasing the steel wire, disposing the steel wire and the diamond bead bearing units in a mold in a manner that the diamond bead bearing units surround the steel wire with a predetermined spacing therebetween; injecting a thermoplastic polyurethane (TPU) material into the mold; and curing the TPU material to form the small-diameter diamond wire saw.

When the diamond wire saw is used in a cutting process for an extended period of time, the diamond bead bearing units are unavoidably detached from the isolation sleeve due to tensile stress generated, even if the isolation sleeve made from TPU materials is flexible, abrasion-resistant, and cold-resistant. Hence, there is plenty of room for improving the bonding strength of the isolation sleeve.

### SUMMARY

Therefore, an object of the disclosure is to provide a diamond wire saw that can alleviate at least one of the drawbacks of the prior art.

According to the disclosure, the diamond wire saw includes a steel wire, a molded sleeve, and a plurality of diamond bead bearing units.

The molded sleeve surrounds and is bonded to the steel wire.

The diamond bead bearing units are separately disposed around and bonded to the molded sleeve. Each of the diamond bead bearing units includes a tubular body and a functional layer covering the tubular body and containing a plurality of abrasive diamond particles. The molded sleeve is made of polyether-type thermoplastic polyurethane, and has a Shore hardness of greater than or equal to 70 D.

### BRIEF DESCRIPTION OF THE DRAWINGS

Other features and advantages of the disclosure will become apparent in the following detailed description of the embodiment with reference to the accompanying drawings, of which:

FIG. 1 is a fragmentary schematic view illustrating an embodiment of a diamond wire saw according to the disclosure;

FIG. 2 is a schematic view illustrating determination of the bonding strength requirement for diamond bead bearing units with respect to a molded sleeve.

### DETAILED DESCRIPTION

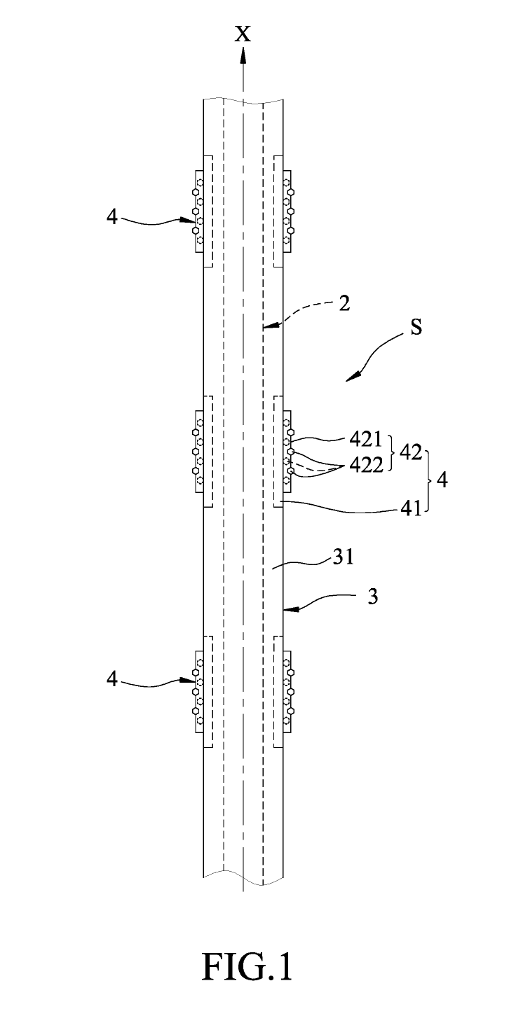

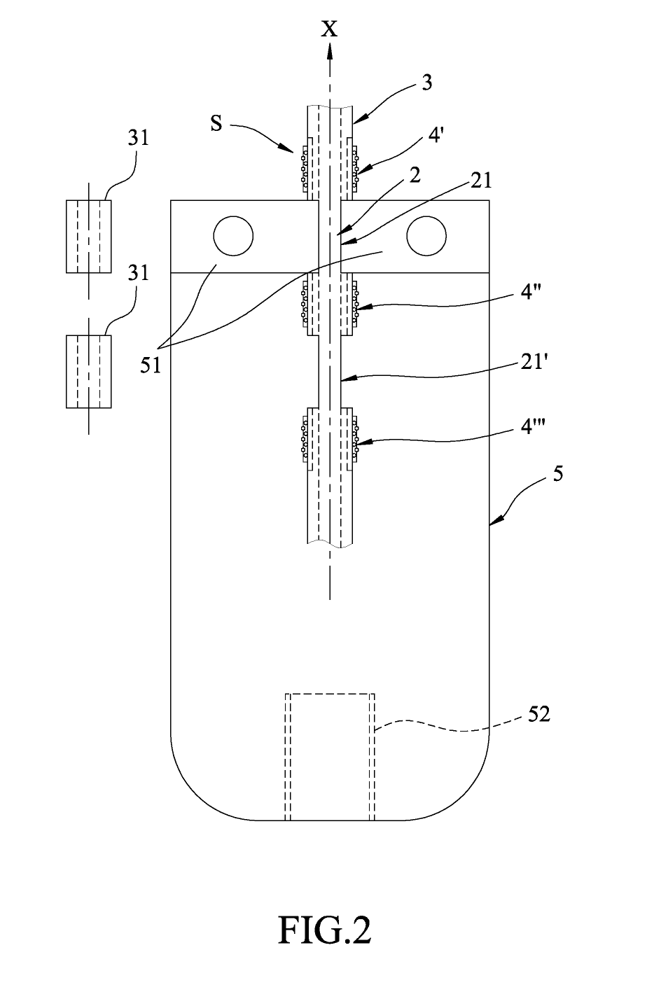

Referring to FIGS. 1 and 2, an embodiment of the diamond wire saw (S) according to the disclosure used for cutting a stone (not shown) includes a steel wire 2, a molded sleeve 3, and a plurality of diamond bead bearing units 4.

The steel wire 2 extends along an axial direction (X) of the diamond wire saw (S). The molded sleeve 3 surrounds the steel wire 2 along the axial direction (X) and is bonded to the steel wire 2. The diamond bead bearing units 4 are separately disposed around and bonded to the molded sleeve 3. Each of the diamond bead bearing units 4 includes a tubular body 41 and a functional layer 42 that covers the tubular body 41 and that contains a plurality of abrasive diamond particles 422. The molded sleeve 3 is made of polyether-type thermoplastic polyurethane, and has a Shore hardness of greater than or equal to 70 D. Preferably, the molded sleeve 3 has a Shore hardness of 72 D. Each of the diamond bead bearing units 4 has a bonding strength of greater than 230 kgf. Preferably, each of the diamond bead bearing units 4 has a bonding strength of greater than 250 kgf. The functional layer 42 of each of the diamond bead bearing units 4 further includes a binder layer portion 421, and the abrasive diamond particles 422 are dispersed on the binder layer portion 421. In the embodiment, the molded sleeve 3 is formed using injection molding techniques.

The required bonding strength of each of the diamond bead bearing units 4 is determined as follows. First, two diamond particle-free portions 31 of the molded sleeve 3 that are respectively sandwiched among three of the diamond bead bearing units 4′, 4″, 4′″ connected in series are removed so as to expose two parts 21, 21′ of the steel wire 2 that correspond in position to the removed diamond particle-free portions 31 of the molded sleeve 3. Then one 21 of the exposed parts 21, 21′ of the steel wire 2 is clamped by a pair of clamping members 52 of a clamping unit 5. The clamping unit 5 is formed with an internal thread that is distal to the clamping members 52 in the axial direction (X) and that is threadedly secured to a tensile testing machine (not shown). Thereafter, a drawing force is applied to the steel wire 2 relative to the internal thread of the clamping unit 5 along the axial direction (X) by the tensile testing machine. The required bonding strength of the diamond bead bearing units 4 is defined by a maximum tensile loading that the diamond bead bearing unit 4″ interposed between the exposed parts 21, 21′ of the steel wire 2 is not moved relatively to the steel wire 2.

In one form, before carrying out the injection molding process, the steel wire 2 is pre-heated at a temperature ranging from 50° C. to 70° C. so as to improve adhesion of the molded sleeve 3 to the steel wire 2.

More specifically, a method of making the diamond wire saw (S) of the disclosure may include the following steps. First, the steel wire 2 is cleaned and degreased. Then the cleaned steel wire 2 and the diamond bead bearing units 4 are disposed in a mold of an injection molding machine (not shown). The diamond bead bearing units 4 are respectively received in cavities of the mold and separately disposed around the steel wire 2 along the axial direction (X), and a drawing force is applied to the steel wire 2 along the axial direction (X) so as to maintain the steel wire 2 under tension. Then, the steel wire 2 is preheated at a temperature ranging from 50° C. to 70° C. and the mold is preheated at a temperature ranging from 60° C. to 90° C. Thereafter, a polyether-type thermoplastic polyurethane material is fed into and compounded in a feeding barrel of the injection molding machine. The feeding barrel includes a nozzle located at an inlet of the mold. The feeding barrel is divided into a first section distal to the nozzle, a second section disposed between the first section and the nozzle, and a third section disposed adjacent to the nozzle and between the second section and the nozzle. The injection molding machine further includes a screw rod movable in the first, second and third sections of the feeding barrel so that the first section has a controlled injection pressure ranging from 90 bar to 100 bar and a controlled injection speed of 20 vol. % (100 Vol. %=104 m/s), the second section has a controlled injection pressure ranging from 75 bar to 90 bar and a controlled injection speed of 50 vol. %, and the third section has a controlled injection pressure ranging from 50 bar to 80 bar and a controlled injection speed ranging from 10 vol. % to 20 vol. %. The polyether-type thermoplastic polyurethane material is pushed by the screw rod to move toward the nozzle and is discharged from the nozzle to the inlet of the mold to fill the mold. The mold has a controlled holding pressure ranging from 20 bar to 30 bar. Thereafter, the polyether-type thermoplastic polyurethane material filled in the mold is cured to form the molded sleeve 3 having a thickness ranging from 1.2 mm to 2.0 mm.

### Example 1 (E1) and Example (E2)

The diamond wire saws of Example 1 (E1) and Example 2 (E2) are both made by the aforementioned method, and the injection pressures and injection speeds are as shown in Table 1. Besides, the polyether-type thermoplastic polyurethane material used in E1 and E2 is ISOTHANE® 3070DU-W (available from Great Eastern Resins Industrial Co. Ltd., Taiwan) that has a Shore hardness of 72 D.

TABLE 1

| | Injection pressure | | | | | |
|---|---|---|---|---|---|---|
| | (bar) | | | Injection speed (vol. %) | | |
| | | Second | third | first | second | third |
| Example | first section | section | section | section | section | section |
| E1 | 90 | 75 | 50 | 20 | 50 | 20 |
| E2 | 100 | 90 | 80 | 20 | 50 | 10 |

※ 100 vol. % = 104 m/s

### Comparative Example 1 (CE1)

The diamond wire saw of Comparative Example 1 (CE1) is made in a manner similar to that of the Example (E1) except that the polyether-type thermoplastic polyurethane material is replaced with Estane® 2103-65D (available from Lubrizol Corporation, the United States) which has a Shore hardness of 65 D, and that the injection molding conditions are modified in accordance with a specification of Estane® 2103-65D provided by the manufacturer.

The diamond wire saw of Comparative Example 2 (CE2) is a commercial diamond wire saw that has a bead size of 7.2 mm beads and that is available from Dellas S.p.a., Italy. The infrared spectrum of absorption of the molded sleeve of the diamond wire saw of CE2 measured by the Fourier transform infrared spectroscopy (FTIR) shows that absorption peaks at 1650 cm-1 and 1220 cm-1, which respectively indicate absorption peaks of polyester and polyether. It demonstrates that the molded sleeve of the diamond wire saw of the Comparative Example 2 (CE2) includes a mixture of polyester-type and polyether-type TPU materials.

The bonding strength of the diamond bead bearing units of each of E1, E2, CE1 and CE2 is measured in accordance with the abovementioned method for determining the required bonding strength of the diamond molded sleeve. Six adjacent ones of the diamond bead bearing units of the diamond wire saw of each of E1, E2, CE1 and CE2 are taken for conducting the bonding strength measurement and an average value of the six measurements is obtained and shown in Table 2. The results shown in Table 2 illustrate that the bonding strength values of the diamond bead bearing units of CE1 and CE2 are less than 230 kgf, while the bonding strength values of the diamond bead bearing units of E1 and E2 are greater than 250 kgf and up to 282.21 kgf.

TABLE 2

| Example and | | |
|---|---|---|
| Comparative | Shore | bonding |
| Example | hardness | strength (kqf ) |
| E1 | 72 D | 282.21 |
| E2 | 72 D | 258.33 |
| CE1 | 65 D | 87.50 |
| CE2 | — | 214.00 |

Therefore, it is demonstrated that the bonding strength of the diamond bead bearing units of the diamond wire saw according to the disclosure can be improved by using the ether-type TPU material having a Shore hardness not less than 70 D, and thus, the service life of the diamond wire saw according to the disclosure can be extended.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A diamond wire saw, comprising:
a steel wire; and
a molded sleeve surrounding and bonded to said steel wire, and
a plurality of diamond bead bearing units disposed around and bonded to said molded sleeve, each of said diamond bead bearing units including a tubular body and a functional layer covering said tubular body and containing a plurality of abrasive diamond particles,
wherein said molded sleeve is made of polyether-type thermoplastic polyurethane, and has a Shore hardness of greater than or equal to 70 D.

2. The diamond wire saw as claimed in claim 1, wherein each of said diamond bead bearing units has a bonding strength greater than 230 kgf.

3. The diamond wire saw of claim 2, wherein the bonding strength of each of said diamond bead bearing units is greater than 250 kgf.

4. The diamond wire saw of claim 1, wherein said molded sleeve has a Shore hardness of 72 D.
